(19) United States
(12) Patent Application Publication
(10) Pub. No.: US 2012/0058747 A1
(43) Pub. Date: Mar. 8, 2012

(54) Method For Communicating and Displaying Interactive Avatar

(76) Inventors: James Yiannios, Las Vegas, NV (US); Mourad Ben Ayed, Menlo Park, CA (US)

(21) Appl. No.: 12/877,180

(22) Filed: Sep. 8, 2010

(51) Int. Cl. H04W 4/00; G10L 11/04; G06T 15/00; G10L 11/00

(52) U.S. Cl. 455/414.1; 704/270; 345/419; 704/E11.001; 704/E11.006

(57) ABSTRACT

A method for communication and for displaying an interactive avatar or hologram corresponding to a remote party.

### FIELD OF THE INVENTION

The present invention relates generally to a method for communicating voice and avatar and more specifically to a method for communicating voice and displaying dynamic avatar.

### BACKGROUND OF THE INVENTION

Telecommunication technology is constantly evolving and is saturated by different overlapping choices or services available. There are the different mobile telecommunication devices with different service providers, there are business lines, there are home numbers, IM messengers, third-party applications (i.e. Skype, Yahoo), Voice Mail, different e-mail accounts and a variety of other highly complicated means of communication. Many professionals find themselves carrying lots of communication devices just to make sure that communication is constant with their family, friends and business associates. Lugging around a laptop to be able to talk to someone through Skype or through a Magic Jack, carrying those extra cell phones, dialing your voicemail number to see if another person called and left a message, making sure the mobile phone you're using is 3G instead of 2G or registering to the international roaming service can be such a terrible inconvenience. The existence of different telecommunication technology with different service providers clutters the communication system of today.

To solve the problem mentioned above, some have come up with the solution of having a system, method and device for providing communications using a distributed mobile architecture as disclosed in United States Patent Application Number US2006/0234774 issued to Lemko Corporation. The device provides a communication path between two or more wireless telecommunication devices via one or more wireless transceivers. The device includes a housing that includes a mobile switching center module and includes a base station controller module. Said mobile switching center module includes a program for switching received telephone calls, establish a peer-to-peer connection with a remote distributed mobile architecture server and a program to transmit telephone calls to a remote distributed mobile architecture server via one or more peer-to-peer Internet protocol connections.

Another prior art is disclosed in U.S. Pat. No. 7,548,763 issued to Shaowei Pan which teaches a method of providing a telephone communication that includes, allowing a group call between four or more participants. Each participant calls from a separate telephone device that communicates with a base transceiver station that is coupled to a distributed mobile architecture server. The method also includes providing full duplex calling capability between all participants via one or more of the distributed mobile architecture servers. One or more participants can disconnect from the group call without affecting other participants remaining on the group call. Further, one or more added participants can connect to the group. Another prior art for the present invention is disclosed in United States Patent Application Number US2007/0202847 issued to Lemko Corporation which teaches an authentication, authorization, and accounting module of a first distributed mobile architecture system that includes a destination preference register. The destination preference register includes a preferred call path for calls to be routed outside of a distributed mobile architecture network that is accessible to the first distributed mobile architecture system.

The preferred call path can be selected from a group comprising a voice over Internet protocol (VoIP) call path, a mobile switching center (MSC) call path, and an integrated services digital network (ISDN) call path. Further, calls that are placed outside of the distributed mobile architecture network from the first distributed mobile architecture system can be established via the preferred call path. Additionally, calls that are routed outside of the distributed mobile architecture network from a mobile subscriber in communication with the first distributed mobile architecture system can be established via the preferred call path.

Another prior art is disclosed in United States Patent Application Number US2008/0039144 issued to Nicholas Labun, et. al. Labun's patent application teaches a device for providing a communication path between two or more wireless telephones via one or more wireless transceivers. The device includes a housing that includes a mobile switching center module and includes a base station controller module. Further, in another particular embodiment, the mobile switching center module includes a program for switching received telephone calls. Additionally, the mobile switching center module includes a program to establish a peer-to-peer connection with a remote distributed mobile architecture server. The mobile switching center module further includes a program to transmit telephone calls to a remote distributed mobile architecture server via one or more peer-to-peer Internet protocol connections.

Another prior art is U.S. Pat. No. 7,050,414 issued to Far Lin. Lin's patent teaches a method comprising the steps of directing a call intended for a mobile to a virtual tandem switch. The virtual tandem switch, which may include multiple converters queries a home location register to obtain call information for the mobile. The call to the mobile is set up over a packet-based transport network. Yet another prior art is disclosed in U.S. Pat. No. 6,411,825 which teaches a telecommunication base station transceiver subsystem that can be easily configured to provide single or multi-carrier frequency service. Capacity is increased and diversity reception is maintained from a single to a dual frequency system without the need for additional antennas. The base station is divided into a main unit and a radio unit such that the radio unit is positioned proximate to the antennas and the main unit is remotely located from the radio unit. Furthermore, a single base station transceiver can provide service via multiple wireless protocols, such as CDMA, TDMA, GSM or Analog. The base station transceiver can also operate on various transmit/receive frequencies as well as variable transmit power settings. Still another prior art is disclosed in U.S. Pat. No. 7,620,033 issued to Alcatel-Lucent USA, Incorporated which teaches a method for optimal path selection in traversal of packets through network address translators. Said patent teaches a reduction of administrative overhead in maintaining network information, rapid convergence on an optimal routing path through the data network, and utilization of only required network resources are realized by a novel method for establishing a call path between network users. The method is based upon deployment of a network information server that stores network topology information and that is addressable by each end user. In this method, the network information server receives a request to establish a call path. The request identifies at least the calling party. In response to the request, the network information server determines a network traversal between the calling party and a root network wherein the network traversal includes call path information about the sub-networks between the calling party and the root network. The request for establishing a call path can also identify the called party. Based on the calling and called party identification, the network information server also determines a second network traversal between the called party and the root network. The second network traversal is sent to either the calling party or the called party or to both the calling and called parties. The server can determine an intersection of the traversals and send the intersection information to the parties. The intersection information is known as a merge point and represents an optimal call path between the parties.

The problem with all the prior arts considered is that none have come up with the solution of unifying the four major telecommunications media to provide its users the power of total convergence and allowing said users access to any of the four major telecommunications media. The prior arts failed to come-up with the solution of providing an access exchange apparatus that would additionally serve as a Wi-Fi router, an ATA Box and a Cable Modem Router.

### OBJECT OF THE INVENTION

A method for communication and for displaying an avatar corresponding to a remote party comprising: on start of a call, acquire data corresponding to avatar definition of remote party; display an avatar corresponding to a remote party on a wireless terminal, periodically analyze inbound voice; on detection of a change in voice characteristics in said inbound voice, automatically display new avatar images corresponding to new voice characteristics.

A method for communicating with a second party using a wireless personal communication device comprising: automatically analyze voice from said second party and determine the language of said second party, if the language of said second party is different from the language preference of the current user, automatically: convert inbound voice to the language of said current user in real-time, convert outbound voice to the language of said second party in real-time, display avatar corresponding to said second party.

### BRIEF DESCRIPTION OF THE DRAWINGS

FIG. 1 illustrates the logical components of an access exchange apparatus according to an embodiment.

FIG. 2 illustrates a communication path through an AEA in which an in-bound call to a mobile telephone is directed to a VoIP communications device according to an embodiment.

FIG. 3 is a flow diagram showing the function of the present invention using a wireless terminal and an avatar interface

FIG. 4 is a flow diagram showing the function of the present invention using a wireless terminal and hologram projection

FIG. 5 is a flow diagram showing the real-time language conversion function

### DETAILED DESCRIPTION

The following terms are used in the description that follows. The definitions are provided for clarity of understanding: API—Application program interface. Blue Tooth—A short-range radio technology aimed at simplifying communications among Internet devices and between devices and the Internet. It also aims to simplify data synchronization between Internet devices and other computers. Bluetooth is a trademark of Bluetooth SIG, Inc. POTS—Plain old telephones. PSTN—Public switched telephone network. VoIP—Voice over Internet protocol. Wi-Fi.™.—Wireless Fidelity. Refers to any type of 802.11 network, whether 802.11b, 802.11a, dual-band, etc. WiFi is a trademark of the Wi-Fi Alliance.

In an embodiment, an access exchange apparatus (AEA) comprises a host controller that bridges telecommunications devices using different transmission media allowing a telecommunications device designed for a particular media to be used to communicate over any other available media. By way of illustration and not as a limitation, a corded and cordless plain old telephones (POTS) may initiate and receive telephone calls over the public switched network (PSTN) or may be bridged to a mobile telephone to initiate and receive telephone calls via the mobile telephone network. A telephone configured for voice over IP (VoIP) may initiate and receive telephone calls via a broadband connection, the PTSN, or a mobile telephone network. A broadband connection may also be used to support high-speed data exchange between the Internet and a computer (e.g., laptop, general purpose computer, personal data assistant) via a wireless or wired LAN or via a mobile telephone connected to a wireless data network.

The AEA comprises a host controller, which comprises software that converts communications sent in one wireless protocol (e.g., Wi-Fi, Bluetooth) to another protocol for reception by a selected receiving device. The host controller also routes communications between devices based on user-established rules.

The AEA comprises a software implementation of a host controller that converts communications sent in one wireless protocol (e.g., WI-FI, Bluetooth) to another protocol for reception by a selected receiving device. The host controller also routes communications between devices based on user-established rules. Additionally, the host controller supports rollover of a call to the mobile Web, to a VoIP telephone, to a broadband connection, or to a landline (PSTN connection). The AEA comprises wireless interfaces that allow a wireless telecommunications device (e.g., mobile telephones) to receive communications from the AEA via a wireless protocol thereby enabling POTS and VoIP communications devices to originate calls for transport over the mobile telephone network and to receive calls originated on the mobile telephone network.

In yet another embodiment, the AEA provides the location of the AEA to emergency operators when “911” is called from any device. Additionally, this embodiment provides devices without fixed locations the attribute of a known location. By way of illustration and not as a limitation, a device without a fixed location may include a POTS telephone when used to communicate over a transmission media other than the PSTN, a mobile telephone and a VoIP telephone.

Another aspect of the invention provides at least a system and a method for substituting and/or modifying an image provided by a speaker engaged in a video telephony conversation. In a preferred embodiment, a first speaker uses a wireless or terminal to communicate with a second terminal. Aspects of the invention provide for processing and transmitting speaker's parameters for dynamic image or avatar during a conversation. When a change in the emotional state is detected in the voice received from a speaker, the dynamic image or avatar corresponding to the speaker automatically adapt to the new emotional state.

One or more facial features of the speaker may be captured and edited into the preferred image or avatar. For example, when the lips of the speaker are incorporated into the preferred image or avatar, the image generated may comprise a lip-synched celebrity or politician. Else, the image may comprise a lip-synched speaker in a preferred facial appearance. For one or more reasons, an individual engaged in a video telephony conversation may wish to substitute his actual facial image with a preferred image or an avatar (i.e., an icon or any type of visual representation of the person speaking into the videophone). A speaker may utilize the system and method of the invention, for example, when he feels that his facial appearance is less than desirable. The speaker may select one of several preferred images or avatars that replaces or substitutes the actual facial image captured by the videophone. The preferred image (i.e., an image that provides an attractive appearance of the speaker) may be stored in a memory of the videophone. This stored image may be used to replace an undesirable image that is captured by the videophone. The avatar may comprise any type of image desired by a user of the videophone. For example, the avatar may comprise a facial image that resembles a celebrity or sports figure. Additionally, the various aspects of the invention allow one or more facial objects of a person's face to be edited (i.e., cropped and inserted) into the avatar or desired image. In a representative embodiment, the objects cropped and inserted may comprise the individual's lips, eyes, and/or nose, for example. As a result, the video presented to a receiving party of a videophone conversation may view the actual movements of the one or more facial objects selected, and a preferred image or avatar retains the actual lip movements present in the captured facial image. For example, an image of a famous celebrity may incorporate the expression provided by the speaker's lips, nose, and eyes. Furthermore, the various aspects of the invention may be adapted to incorporate one or more background images with the avatar. For example, a facial avatar may be presented pictured in a scenic environment. The scenic environment may be a country setting or a beach setting, for example.

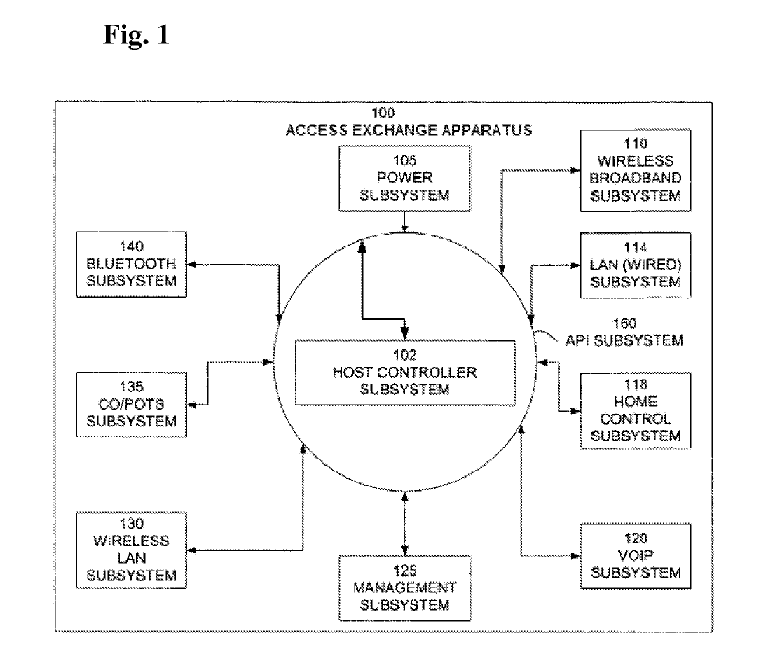

FIG. 1 illustrates the logical components of an access exchange apparatus (AEA) according an embodiment. Referring to FIG. 1, AEA 100 comprises host controller subsystem (HCS) 102, a power subsystem 105, a wireless broadband subsystem 110, a LAN (wired) subsystem 114, a home control subsystem 118, a VoIP subsystem 120, a management subsystem 125, a wireless LAN subsystem 130, a CO/POTS subsystem 135, a Bluetooth subsystem 140, and an API subsystem 160.

The HCS 102 communicates via API subsystem 160 to the communications subsystems (110, 114, 118, 120, 130, 135, and 140) and the management subsystem 125 to enable a telecommunications device designed for a particular media to be used to communicate over any other available media. In an embodiment, API subsystem 160 comprises a single API or multiple APIs.

The HCS 102 comprises a central processing node for the AEA 100. In an embodiment, the HCS 102 comprises a Pentium.™.-class CPU running an embedded LINUX.™.OS (not illustrated). However, this is not meant as a limitation. As will be appreciated by those skilled in the art, other processors and operating systems may be used without departing from the scope hereof. The HCS 102 further comprises software that provides logic and instructions so as to permit communications between the various subsystems and communications devices. Additionally, the HCS 102 controls the API subsystem 160 that enables communications to the HCS software.

In an embodiment, the HCS 102 supports a power failure safeguard mechanism such as battery holdover for short duration outages and longer-term holdover mechanisms such as flash memory storage of system and configuration data. The HCS 102 automatically reboots on power restoration.

Power subsystem 105 provides power to all subsystems of the AEA 100. In an embodiment, power subsystem 105 comprises an AC transformer/converter compatible with both US and European electrical systems. The transformer/converter provides DC power to AEA 100 via a single prong male connector.

Wireless broadband subsystem 110 provides connectivity to wireless broadband services offered by third parties. By way of illustration and not as a limitation, wireless broadband subsystem 110 provides an interface to broadband wireless networks such as Universal Mobile Telecommunications System (UMTS) compliant modem and other compatible “3G” data networks as well as unlicensed broadband networks such as WiMax and Zigbee.

Wireless LAN subsystem 130 comprises a wireless access point for AEA 100. In an embodiment, wireless LAN subsystem 130 provides connectivity to WI-FI compliant devices. Wireless broadband subsystem 110 further comprises a network address translation (NAT) router and a DHCP server that issues private IP addresses to network devices (computers, laptops, PDAs, VoIP gateways to name a few) allowing these devices to share the wireless broadband subsystem 110.

In an alternative embodiment, wireless LAN subsystem 130 comprises a user interface with a visual avatar image or representation of the user (in two-dimensional or three-dimensional model), whereby the visual avatar image changes depending on characteristics of the received voice, such as pitch, tone, and language.

In another alternative embodiment, wireless LAN subsystem 130 comprises a hologram projector, whereby the visual hologram image changes depending on the pitch of the received voice.

Management subsystem 125 is utilized by both the subscriber and a system administrator. Management subsystem 125 enables a communications device to detect and register a mobile phone over a Bluetooth connection, configure TCP/IP ports, configure a NAT router and a DHCP server, and enable forwarding of mobile calls, and enables communication with a carrier's network and back office system to enable features on the mobile phone. Management subsystem 125 comprises a data store for storing user information, and user preferences (for example, ring tones and inbound and outbound call routing). In an embodiment, management subsystem provides the location of the AEA to an emergency assistance service when an emergency assistance number is called from any device. Additionally, this embodiment provides devices without fixed locations the attribute of a known location. By way of illustration and not as a limitation, a device without a fixed location may include a POTS telephone when used to communicate over a transmission media other than the PSTN, a mobile telephone and a VoIP telephone. The location information may be stored expressly by the user or gleaned from the user profile information. By way of illustration and not as a limitation, the emergency assistance service may be a “911” operator.

In yet another embodiment, Bluetooth subsystem 140 monitors the external mobile network signal strength and mobile phone battery strength of a Bluetooth compliant mobile telephone and reports the current measurement to management subsystem 125. Management subsystem 125 applies rules to determine the behavior of incoming and outgoing calls depending on the current external mobile network signal or battery strength. By way of illustration and not as a limitation, if the external mobile network signal strength of the mobile telephone is below a pre-determined first threshold, the management subsystem directs the mobile telephone to issue a forwarding command to the external mobile network to forward calls to a specified number. The forwarding command is cancelled if the signal strength improves to a second threshold value. Additionally, the management subsystem 125 issues an alert to the user that forwarding has been invoke or canceled. In an embodiment, the alert comprises an audio tone or a visual signal. In still another embodiment, the management subsystem 125 rings a communications device connected to the AEA 100 and plays an audio message in a selected language.

In yet another embodiment, if the signal strength of the external mobile network is below the first threshold, outbound calls are directed away from the mobile telephone and placed over a different communications device.

The CO/POTS subsystem 135 comprises 2-wire interfaces (RJ-11s) that enable connection to the PSTN or to a POTS device. In an embodiment, a CO/POTS subsystem 135 comprises two RJ-11 interfaces. A first RJ-11 interface is available for connection to the PSTN (FXO/FXS) and a second RJ-11 interface is connected to the inside wiring. Both RJ-11 interfaces may connect to the inside wiring if no CO line is present. When an RJ-11 interface is connected to a CO line, the CO/POTS subsystem 135 detects the presence of CO-provided power and automatically implements the following capabilities: Provide support for analog voice to and from the PSTN Receive on-hook/off-hook information from a station and present an off-hook command to the PSTN on demand Detect ringing and other conditions and present the information to the station connection Pass all DTMF, flash, and on-hook/off-hook signaling generated at the station to the PSTN Detect and support CLASS features such as caller ID, 3-way calling, call waiting, etc.

In this embodiment, when an RJ-11 interface is connected to a station (e.g., POTS or a cordless telephone) the CO/POTS subsystem 135 detects the absence of power and implements the following station interface capabilities: Provide support for 2-way analog voice to the station end Provide ringing current to the station Detect on-hook/off-hook states and provide dial tone to the station Provide support for DTMF signaling to and from the station Provide echo cancellation Provide support for CLASS features such as Caller ID, 3-way calling, call waiting, etc. Provides gain enhancement capabilities which will enable to user of the VoIP or PSTN phones 235 to increase the volume of the call to compensate for the degradation of the wireless or VoIP call.

In addition, the CO/POTS subsystem 135 determines when power to the AEA 100 is not present and to provide a POTS/station line connection to a CO line to allow for PSTN calling. When power is restored to the AEA 100, the CO/POTS subsystem 135 maintains calls in progress.

The Bluetooth subsystem 140 comprises a Bluetooth protocol stack, radio and a processor that convert voice and data per the most recent Bluetooth specification. In an embodiment, Bluetooth subsystem 140 is complaint with Bluetooth specification version 1.2.

In another embodiment, Bluetooth subsystem 140 comprises a plurality of Bluetooth protocol stacks to permit the AEA 100 to backward compatible with Bluetooth enabled mobile phones while remaining compatible with the most current mobile phones that incorporate a Bluetooth feature.

In an embodiment, the Bluetooth subsystem 140 communicates with the HCS 102 via a defined API that is capable of at least seven simultaneous phone connections with a maximum range of range of 30 meters. This is however, but one example and is not meant as a limitation in either the number of phone calls supported or the range of those phone calls.

An API subsystem 160 manages connectivity between the various subsystems and the HCS 102. Commonality is desired in the API(s) and ideally a single API would be utilized to interconnect all current and future subsystems. In an embodiment, the API(s) are simple, high-level and log gable.

Home control subsystem 118 allows devices within the home to be controlled remotely by commands sent from HCS 102. The Home control subsystem connects to various appliances and home entertainment systems through the AEA over the internal wired or wireless network to control these devices. In an embodiment the user accesses, thorough, the AEA, the home entertainment system to initiate a recording of a movie on a satellite network.

In another embodiment, the AEA offers the ability to display call information on the TV screen while viewing a program and offers the subscriber the option of taking the call using the existing remote control. The system would then go off hook and play over the home entertainment speakers. The system would also offer the ability to direct the call to the AEA where a customized greeting would play.

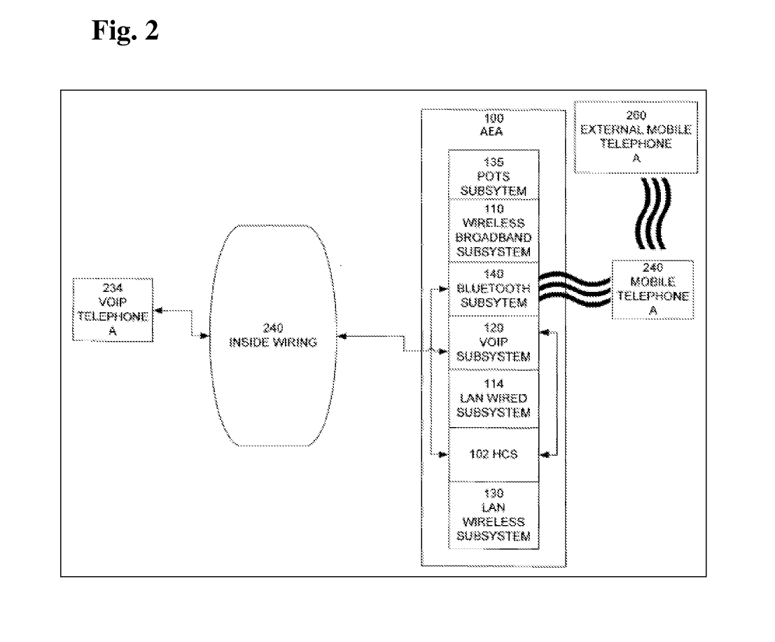

FIG. 2 illustrates a communication path through AEA in which an in-bound call to a mobile telephone is directed to a VoIP communications device according to an embodiment Referring to FIG. 2, a Bluetooth-compliant mobile telephone A 240 is configured to communicate with an AEA 100 via a Bluetooth subsystem 140. The VoIP subsystem 120 is connected to a VoIP telephone A 234 via the inside wiring 240. VoIP subsystem 120 communicates with Bluetooth subsystem 140 via HCS 102.

An external mobile telephone A 260 dials the number of mobile telephone A 240. The AEA 100 detects the incoming call and signals the VoIP telephone A 234 to ring. The call is answered by a subscriber (not illustrated) and communications between the calling external mobile telephone A 260 and VoIP telephone A 234 are bridged via the AEA 100 and mobile telephone A 240.

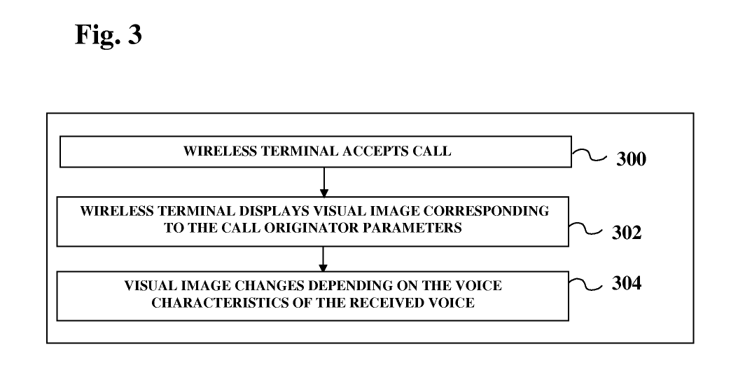

FIG. 3 illustrates a flow diagram showing the function of the present invention for a wireless terminal using avatar interface. In step 300, wireless terminal 110, 130 or 140 accepts a call, and in step 302, it displays a visual image, an animation or an avatar.

The visual image, animation, dynamic virtual interface or avatar correspond to preferences set by other party to the call who can control the avatar's looks, movements, reactions, voice, language, behavior, history, and any other feature. On start of a call (which may be a VoIP call, a 2G/3G/4G call or other), it downloads avatar data corresponding to avatar definition and displays an avatar corresponding to a remote party, it then periodically analyzes the inbound voice, and on detection of a change in emotional state in said inbound voice, it automatically displays avatar images corresponding to the emotional state in step 304. The visual image, animation or avatar change as a result of changes in received voice pitch, intonation, volume, expressions etc. For example, if laughing is detected, the wireless terminal displays a laughing face. If anger is detected, an angry face will be displayed. The displayed avatars are dynamic.

The avatar dynamic images can be a computer generated character, a cartoon character, a historically significant public figure, a character from a video game, a literary character, a movie character, an animal character or any other set of dynamic images.

In another embodiment, the remote party sends instructions indicating a change in avatar parameters such as appearance, motion parameters, language, sound. The avatar applies those changes in real-time.

In another embodiment, the user inputs instructions indicating a change in avatar parameters such as appearance, motion parameters, language, sound. The avatar applies those changes in real-time.

In another embodiment, the invention comprises a system for converging voice and avatars comprising a personal communication gateway for interfacing to the PSTN network, to the mobile network, to broadband internet, and with a wireless terminal. On incoming call, the system detects avatar parameters, and analyzes inbound voice. On detection of a change in emotional state in the inbound voice, it automatically displays avatar images corresponding to the emotional state.

In another embodiment, the invention comprises a system for converging multiple telecommunications media (fixed, wireless, internet and cable) and multiple communication services (SMS, MMS, chat, video phone, language service, Skype service, Face book service, avatar interface and hologram interface) across those multiple telecommunications media.

In another embodiment, the avatar is a 3-D avatar.

In yet another embodiment, on detection of a change in voice characteristics in said inbound voice, the processor on the receiving terminal automatically applies updates to the avatar with visual effects corresponding to new voice characteristics. For example, on detection of crying, the processor will add tears. On detection of laugher, the process will update the avatar image to reflect a laugh or a smile. Similarly, on detection of anger or confusion, the processor will transform the avatar image to reflect anger or confusion using image processing algorithms that can alter images to reflect an emotion. Such algorithms and software are available on the market.

In yet another embodiment, said processor applies image transformation techniques corresponding to lip movement to the avatar images. The lip movements are synchronized with the voice received from the remote party

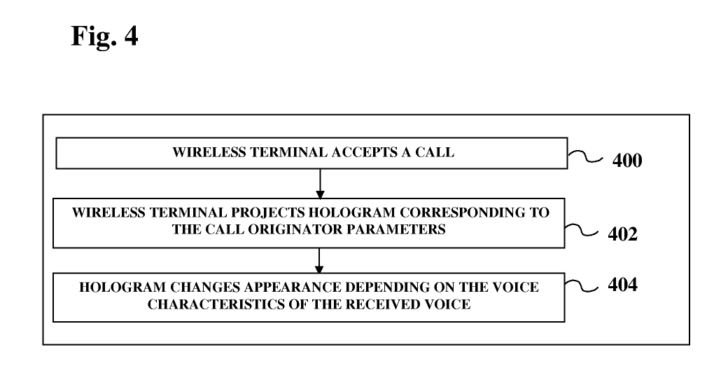

FIG. 4 illustrates a flow diagram showing the function of the present invention for a wireless terminal using hologram projection. In step 400, wireless terminal 110, 130 or 140 accepts a call, and in step 302, it projects a hologram. The hologram correspond to preferences set by other party to the call who can control looks, movements, reactions, voice, language, behavior, history and any other feature. In step 404, the hologram changes as a result of changes in received voice pitch, intonation, volume, expressions etc.

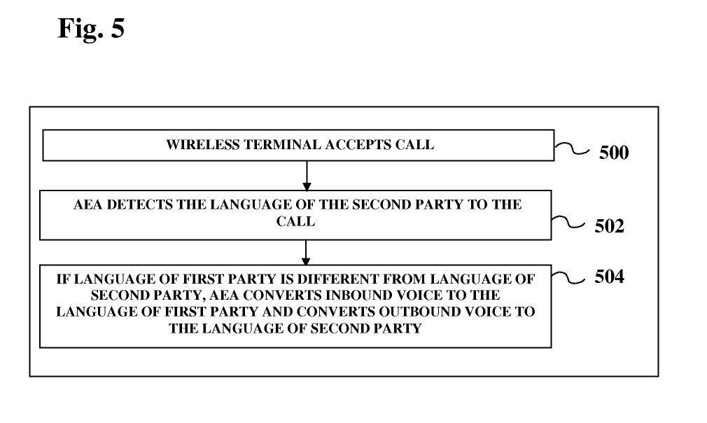

FIG. 5 illustrates a flow diagram showing the function of the present invention for a wireless terminal. In step 500, wireless terminal 110, 130 or 140 accepts a call, and in step 502, it detects the language of first party and of second party to the call. The language is determined by analyzing a voice stream sample in real-time.

In step 504, if the language of the first party is different from the language of the second party, the access exchange apparatus or the wireless terminal automatically converts the incoming voice to the language of the first party, and the outgoing voice to the language of the second party.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1- A method for communication and for displaying an avatar corresponding to a remote party comprising:
on start of a call, acquire data corresponding to avatar definition of remote party;
display an avatar corresponding to a remote party on a wireless terminal, periodically analyze inbound voice;
on detection of a change in voice characteristics in said inbound voice,
automatically display new avatar images corresponding to new voice characteristics.

2- The method of claim 1 wherein said voice characteristics are selected from the set comprised of: tone, pitch, laugher, crying, anger.

3- The method of claim 1 wherein said call is a VoIP call.

4- The method of claim 1 wherein said avatar is selected from the set comprised of:
a computer generated character,
a cartoon character,
a historically significant public figure,
a video game character,
a literary character,
a movie character,
an animal character.

5- The method of claim 1 wherein:
on receipt of instructions from said remote party, said instructions indicating changes in avatar parameters selected from the set comprising: appearance, motion parameters, language and sound,
said changes are applied immediately.

6- The method of claim 1 wherein:
if the language of said remote party is different from the language preference of current user, automatically:
convert inbound voice to the language of current user,
convert outbound voice to the language of remote party.

7- The method of claim 6 wherein:
said language is determined by analyzing a voice stream sample from said remote party.

8- The method of claim 1 comprising:
projecting a 3-dimensional hologram corresponding to said avatar.

9- The method of claim 8 whereby:
on detection of a change in voice characteristics in said inbound voice, automatically display new hologram corresponding to new voice characteristics.

10- The method of claim 1 comprising:
projecting a 3-dimensional hologram corresponding to said remote party.

11- The method of claim 1 comprising:
connecting to a remote communication system,
obtaining avatar data from said communication system,
displaying said avatar.

12- The method of claim 1 wherein said avatar is a 3-D avatar.

13- A method for communicating with a second party using a wireless personal communication device comprising:
automatically analyze voice from said second party and determine the language of said second party,
if the language of said second party is different from the language preference of the current user, automatically:
convert inbound voice to the language of said current user in real-time, convert outbound voice to the language of said second party in real-time,
display avatar corresponding to said second party.

14- A method for communication and for displaying an avatar corresponding to a remote party comprising:
on start of a call, acquire data corresponding to avatar definition of remote party;
display an avatar corresponding to a remote party on a wireless terminal, periodically analyze inbound voice;
on detection of a change in voice characteristics in said inbound voice,
automatically apply update said avatar with visual effects corresponding to new voice characteristics.

15- The method of claim 14 wherein said visual effects are selected from the set comprised of: laugh, smile, tears, crying, anger, confused.

16- The method of claim 14 comprising: applying lip movement to said avatar, said lip movements are synchronized with the voice received from said remote party.
